(19) United States
(12) Patent Application Publication
(10) Pub. No.: US 2004/0034601 A1
(43) Pub. Date: Feb. 19, 2004

(54) System and method for content distribution and reselling

(76) Inventor: Erwin Kreuzer, Vienna (AT)

Correspondence Address: Erwin Kreuzer, Goldschlagstrasse 26/5/14, Vienna, 1150, AT

(21) Appl. No.: 10/219,958

(22) Filed: Aug. 16, 2002

(51) Int. Cl. G06F 17/60

(52) U.S. Cl. 705/52

(57) ABSTRACT

This invention enables users of communication networks such as the Internet to trade content over a communications network in a legal and fair way, ensuring the fair division of proceeds between the involved parties. This invention shares the tasks of publishing content, distributing content and billing for the content between different parties. The prospective content-customer is not reliant on a single source and can use modern technology such as P2P, while the complex verification and billing process is done by a professional and reliable institution. A content publisher can easily set up an immense network of resellers. Resellers and Content Publishers can be rewarded for their efforts.

### FIELD OF THE INVENTION

The present invention generally relates to content distribution systems and content distribution methods.

### BACKGROUND OF THE INVENTION

The Internet is a huge, international network of computers that can communicate with each other using standard protocols such as TCP/IP. Innovations such as the World Wide Web (WWW) have made it easy for everyone to use the internet for finding and accessing information from numerous sources worldwide easily.

In the beginning of the Internet, the task of providing information and data required expensive servers with powerful hard- and software, and therefore only financially strong institutions like major enterprises, universities and governmental organizations could afford to run servers in order to offer information to the public. Nevertheless, the number of servers and information providers grew steadily.

The software needed for accessing and viewing the data with client-computers (eg. Web-Browsers such as Netscape™), was much cheaper or often “for free”, and required less expensive hardware. With the growing spectrum of contents available, the number of internet-users increased rapidly. But in the meantime, developments such as the open source software movement and the big drop in prices of powerful hardware have made the resources needed to provide data on the internet much cheaper, enabling almost everyone to run an internet-server on common computer-hardware such as a Desktop-PC.

Peer-to-peer-computing (“P2P”) is only the next step: P2P is a type of decentralized computing, where computers communicate directly with each other, abandoning the distinction between client and server. Participants in a Peer-to-peer-computing network can share computer resources such as processing power or storage. Users of P2P-computing-software such as Napster™, Kazaa™ and Gnutella™ share some of the data stored on their computers with other users. Therefore, P2P-software has enabled many people not only to retrieve data with their home-computer, but also to provide data to other users very easily. Today, thousands of Internet-users use P2P-Software such as Kazaa™ and Gnutella™ to share music, film, pictures and other contents with other users.

While these new technologies created a huge new market for technology, services and contents, they are also a threat to certain industries. The mentioned technologies have not only enabled consumers to access information and data made available to them by the authors, artists and copyright-holders, but also to share and give away copyrighted data such as music, film, computer-software and electronic books, often violating the rights of the authors, artists, developers and copyright holders.

Many attempts have been made to stop this development and to keep internet-users from sharing copyrighted data, but neither Lawsuits against illegal content-providers and technology-providers, nor the application of new copy protection, encryption and watermarking technologies have yet significantly limited the growing number of copyright infringements.

This invention takes a different approach to this problem by turning the “internet-threat” into an “internet-potential”: It applies technology in order to encourage users to acquire and redistribute various contents and data in a way, that lets all the parties concerned such as authors, artists, publishers and copyright-holders participate, while most of the available and recently developed technologies such as watermarking, copy-protection and encryption attempt to keep internet-users from sharing information and data.

Other advantages of this invention are, that the content does not have to be altered or marked in any way, which is of interest to people who fear the invasion of their privacy, and that the system does not depend on a specific kind of data-transfer such as HTTP (Hypertext Transfer Protocol, the Protocol used by the World Wide Web) or FTP (File Transfer Protocol, broadly used for the transfer of files via the internet). It also does not necessarily depend on data-transfer over a network, the content could be transferred on a Floppy-Disk, CD-ROM, DVD or other mediums as well, which may be useful if very large amounts of data are to be transferred. Anyhow, the transfer over a network such as the internet is the preferred method.

As the content is not altered, the content-buyer is not limited in his usage of the content in any way, and the system is applicable to any kind of digital content, information and data such as text, music, video, electronic books or software. While the system may use common secure forms of network communication such as SSL (Secure Socket Layer, a protocol developed by Netscape™, that works by using a public key to encrypt data that's transferred over a network) for secure communication between the participants of the system and file transfer, but it does not necessarily encrypt the content in order to limit it's usage or distribution. In addition, as the content-buyer is not limited in its usage of the content, the content-user does not have to authenticate his everyday usage of the content, e.g. by connecting to licensing servers or rights managements servers after the completion of the content sale transaction as required by other systems. This invention enables the content-buyer to use the acquired content in any way and on any device he desires. In addition to that, this invention enables the user to resell the acquired content in a fair way, ensuring the fair division of proceeds between the involved parties such as authors, copyright owners etc.

This invention shares the tasks of publishing content, distributing content and billing for the content between different parties. The prospective content-customer is not reliant on a single source, while the complex billing process is done by a professional and reliable institution. The content publisher can easily set up an immense network of resellers.

### BRIEF SUMMARY OF THE INVENTION

While users of communication networks such as the Internet are often considered as copyright infringers or “pirates” by the entertainment and software industry, this invention provides means for using their efforts and equipment as an immense network of resellers. While common technology tries to keep users from copying or reselling content, this invention encourages them to do so in a legal and fair way.

Users, who buy content using the invention, are in a position to use and to resell the legally acquired content. The system employs a Clearing House that processes all transactions, assures, that contents are transmitted correctly and makes possible, that all parties, including content publishers (authors, artists, copyright holders) and resellers, are rewarded. The Clearing House stores the transaction history of each digital content that is sold in Content Holder Certificates or in a database for later reference.

### BRIEF DESCRIPTION OF THE DRAWINGS

FIG. 1 is an illustration of a Content Distribution and Reselling System according to one embodiment of the present invention.

FIG. 2 illustrates the Content Registration Process according to one embodiment of the present invention.

FIG. 3 illustrates the Content Selling Process according to one embodiment of the present invention.

FIG. 4 illustrates the Content Reselling Process according to one embodiment of the present invention.

FIG. 5 illustrates a simple Content Holder Certificate according to one embodiment of the present invention.

FIG. 6 illustrates an advanced Content Holder Certificate according to one embodiment of the present invention.

FIG. 7 illustrates the data maintained in a Content Holder Items Table stored at the Clearing House Site or a Database Site accessible by the Clearing House Site according to one embodiment of the present invention.

FIG. 8A and FIG. 8B illustrate an example for a basic Content Holder Certificate according to one embodiment of the present invention.

FIG. 8C illustrates, according to one embodiment of this invention, how the transaction history stored in the List of Content Holder IDs is created.

FIG. 9 is a flow diagram illustrating a process in which the Clearing House Site generates a new Content Holder Certificate (CHC) and calculates rewards for the parties that participated in a content transaction according to one embodiment of the present invention.

FIG. 10 is a flow diagram illustrating a process in which the Clearing House Site uses a Database in order to process Content Transactions and to calculate commissions for the parties that participated in a content transaction according to one embodiment of the present invention.

### DETAILED DESCRIPTION OF THE INVENTION

### I. System Overview

The Content Distribution and Reselling System provides a technical platform for the commercial distribution of digital contents and the allocation of generated revenues to the participating parties over communication networks such as the internet.

The term “Digital Content” or “Content” or “Content-File” refers to data stored in digital format, such as text, video, music, software programs, electronic books, pictures and other documents.

In the context of this invention “to sell content” or “to resell content” means to sell a digital copy of a legally acquired digital content to another user using the system described in this document. So, when a user has sold content, he can still carry on using the content, or sell it to yet another user. It is therefore possible, that one user sells multiple copies of content, e.g. of a digital music file. As soon as the buyer of content has completed the buying-process and is therefore a legal holder of the content, he is also in a position to start using and reselling the acquired content.

In the context of this invention “User-ID” or “Content-ID” or other “IDs” mean data identifying a Content, a User of the System or other Items. In a preferred embodiment of the invention, the Clearing House Site assigns unique numerical values or strings to all Contents and Users which are then used to identify them indisputable. In another embodiment of the invention, the full name of the user or of the content is used in order to identify them.

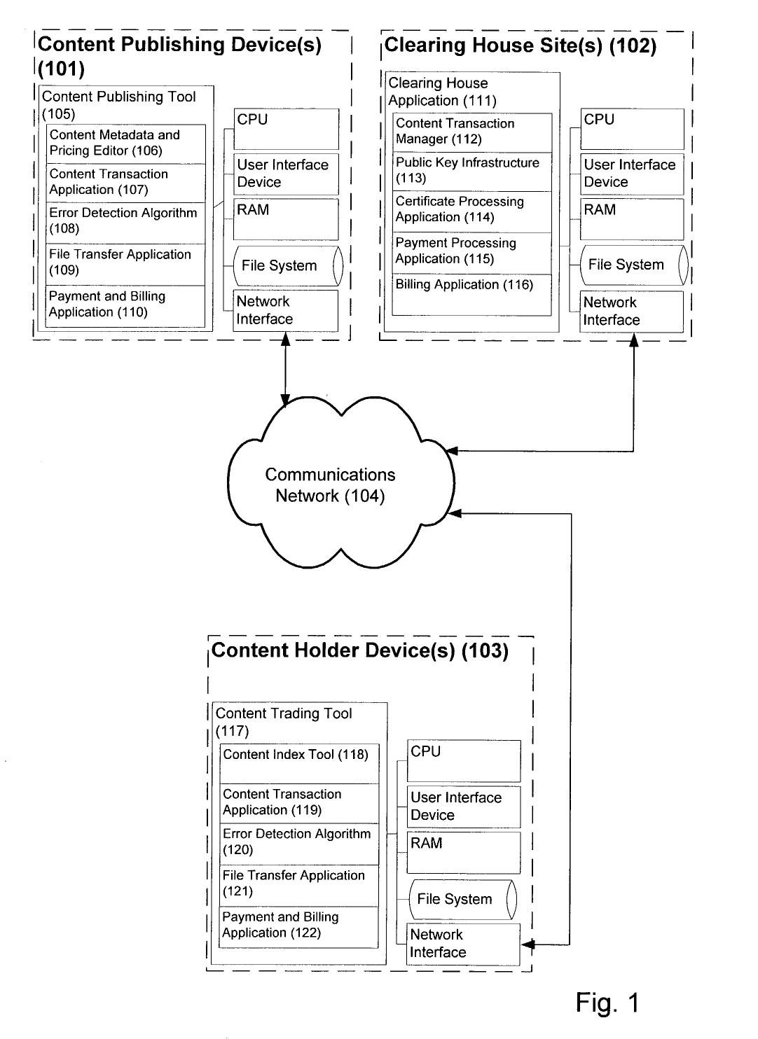

Referring now to FIG. 1, there is shown an illustration of a Content Distribution and Reselling System according to one embodiment of the present invention. The Content Distribution and Reselling System includes at least one Content Publishing Device (101), which is used by Content Publishers to bring new content into the system, at least one Clearing House Site (102), which is used to process transactions and payments and to issue certificates, and at least one Content Holder Device (103), which are used to acquire and resell content. In a preferred embodiment of the invention, the Content Distribution and Reselling System communicates over a Communications network such as the Internet or over a wireless network. In a preferred embodiment of the invention, the Content Distribution and Reselling System uses secure communication technologies such as SSL (Secure Socket Layer), S/MIME (Secure Multipurpose Internet Mail Extensions), IPsec (IP Security Protocol) or SHTTP (Secure Hypertext Transfer Protocol) for any data transmission.

The Content Publishing Device (101) includes a Central Processing Unit (CPU), a User Interface Device, Random Access Memory (RAM), a File System (Disk Storage) and a Network Interface for communicating over a communications network. The Content Publishing Device (101) runs a Content Publishing Tool (105). The Content Publishing Tool (105) includes a Content Metadata and Pricing Editor (106), which is used to collect meta-data such as the artists name, the title, the price, terms and conditions of the content which is to be published. In addition, the Content Publishing Tool (105) includes a Content Transaction Application, which communicates with the Clearing House Sites and the Content Holder Devices over a communications network in order to process transactions. In addition, the Content Publishing Tool (105) includes an Error Detection Algorithm (108), which generates a checksum of a published content in order to prevent transmission errors or fraudulent manipulation of the content. In addition, the Content Publishing Tool (105) includes a Payment and Billing Application (110), which is used for payments and to balance the accounts with the Clearing House Site(s) (102). In a preferred embodiment, the Content Publishing Tool (105) also includes a File Transfer Application (109) to transfer the content to a buyer via a communications network. Examples of such a File Transfer Application are Web-Server-Software, FTP-Server-Software or P2P-File-Sharing-Software.

The Clearing House Site (102) includes a Central Processing Unit (CPU), a User Interface Device, Random Access Memory (RAM), a File System (Disk Storage) and a Network Interface for communicating over a communications network.

The Clearing House Site (102) runs a Clearing House Application (111). The Clearing House Application (111) includes a Content Transaction Manager (112), which processes Communication and Transactions with Content Publishing Devices (101) and Content Holder Devices (103). In addition, the Clearing House Application (111) includes a Public Key Infrastructure (113), which generates digital signatures and encrypts and decrypts Content Holders Certificates. In addition, the Clearing House Application (111), includes a Certificate Processing Application (114), which generates Content Holder Certificates and extracts Data from Content Holder Certificates. In addition, the Clearing House Application (111) includes a Payment Processing Application (115), which processes payments and in a preferred embodiment provides means for communication with credit card companies, electronic cash service providers, electronic payment providers and online banking providers over a communications network such as the internet. In addition, the Clearing House Application (111) includes a Billing Application (116), which calculates rewards, keeps the accounts for Publishers and Content Holders and stores proceeds and expenses for purchases and sales of contents, and for other services. In a preferred embodiment, the Clearing House Site (102) also runs a Database or has access to a separate Database Site in order to store data such as Content Meta-Information, User Accounts and similar information.

The Content Holder Device (103) includes a Central Processing Unit (CPU), a User Interface Device, Random Access Memory (RAM), a File System (Disk Storage or RAM) and a Network Interface for communicating over a communications network.

The Content Holder Device (103) runs a Content Trading Tool (117). The Content Trading Tool (117) includes a Content Index Tool (118), which keeps track of the available contents and certificates and displays this information to the User of the Content Holder Device (103). In a preferred embodiment, this information, or parts of this information, can also be shared with users of other Content Holder Devices. In addition, the Content Trading Tool (117) includes a Content Transaction Application (119), which communicates with the Clearing House Site(s) (102), Content Publishing Devices (101) and other Content Holder Devices (103) over a communications network in order to process transactions. In addition, the Content Trading Tool (117) includes an Error Detection Algorithm (120), which generates a checksum of a received content and compares the checksum to the Publishers' original checksum in order to prevent transmission errors or fraudulent manipulation of the content. In addition, the Content Trading Tool (117) includes a Payment and Billing Application (122), which is used for payments and to balance the accounts with the Clearing House Site(s) (102). In a preferred embodiment, the Content Trading Tool (117) includes a File Transfer Application (121) to provide the buyer with the acquired content-file to via a communications network. Examples of such a File Transfer Application are Web-Server-Software, FTP-Server-Software or P2P-File-Sharing-Software. In a preferred embodiment, Content Holder Device also provides means for viewing the content, e.g. player-software for music and video-files, a viewer for text files etc.

In another embodiment of the invention, a Content Publishing Tool (105) and a Content Trading Tool (117) run on one device including a Central Processing Unit (CPU), a User Interface Device, Random Access Memory (RAM), a File System (Disk Storage) and a Network Interface for communicating over a communications network, at the same time, in order to enable the Content Publisher to publish Content and to trade Content using the same device.

### II. System Uses and System Functional Elements

User Registration

In a preferred embodiment of the invention, all users who intend to use the system have to register with the Clearing House Site (102) first. The Clearing House Site (102) then assigns a User-ID and a Password to the respective user and stores the data. The User-ID is used to identify the user. In a preferred embodiment, the User-ID is a numerical value. In another embodiment, the User-ID is a string of characters complying with the ASCII-Standard. The combination of a User-ID and a password are then used by Users of the System to log on to the Clearing House Site in order to process transactions. In another embodiment of the invention, the Clearing House Site (102) issues a digital certificate to the newly registered user instead of the User-ID and password combination, which the user of the system uses in order to log on to the Clearing House Site. In one embodiment of the invention, said digital certificate complies with the X.509 Standard.

Content Registration

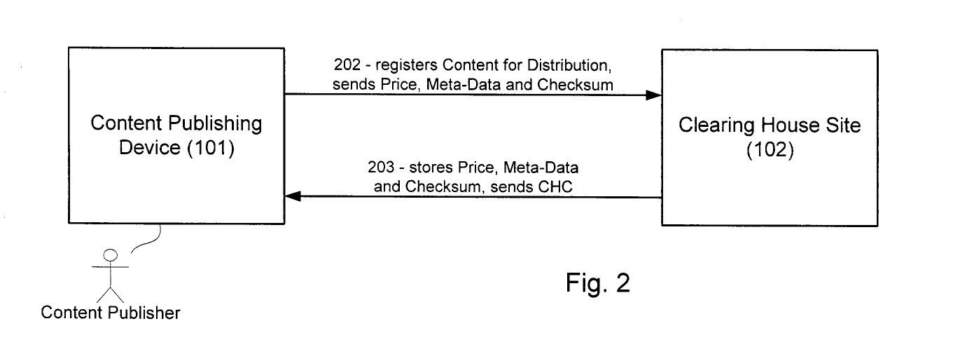

FIG. 2, illustrates the registration of a Content with the Clearing House according to one embodiment of the innovation. A Content Publisher, e.g. an employee of a publishing house or an artist, wants to publish content. He uses the Content Publishing Tool (105) of the Content Publishing Device (101) to enter the required information about the content (so called “Meta-Data”, e.g. Artist, Title, Publisher, Copyright, Filename, File Format) and to specify the “Price, Terms and Conditions” and the “Distribution Basis” of the content, and uses the Error Detection Algorithm (108) to generate a checksum of the Content-File.

In a preferred embodiment of the invention, a standardized checksum algorithm is used for the generation of the checksum. Examples for standardized checksum algorithms are “CRC” and “MD5”, they are broadly used in networking technology (e.g. in the Ethernet-Standard) to make sure, that data is transmitted without errors. They can also be used to make sure, that data was not manipulated or infected with viruses etc. The originator of the content generates a checksum, transmits the content and the checksum. The recipient of the data generates a checksum as well, using the same algorithm. This checksum is compared with the original checksum, if they don't match, some error occurred, the transmission can be repeated or other sources of error can be searched for. More information on generating and using checksums can be found in “A Painless Guide to CRC Error Detection Algorithms” by Ross Williams (http://www.riccibitti.com/crcguide.htm).

The “Price, Terms and Conditions” Information contains the price a content buyer has to pay for acquiring the content and, in one embodiment of the invention, other terms or reselling limitations where given.

The “Distribution Basis” contains information about how the volume of sale generated by content selling and reselling is to be shared between the involved parties. The following is an example for a “Distribution Basis” according to one embodiment of the invention:

ContentPublisher: 50%

ContentSeller: 15%

PreviousContentHolders: 15%

ClearingHouse: 20%

This Information is used by the Billing Application (116) of the Clearing House Site (102) in order to calculate rewards for the parties involved in a content transaction. According to the example above, if a Content Buyer acquired a Content for USD 10.00, the Billing Application (116) would calculate the following rewards: USD 5.00 for the Content Publisher, USD 1.50 for the Content Seller, USD 2.00 for the Clearing House, and USD 1.50 to be shared between the Previous Content Holders as found in the Content Holder ID List in the Content Holder Certificate. In another embodiment of the Invention, more involved parties can be rewarded: the participating Internet Service Providers, the participating Digital Storage Providers, additional participating Clearing House Sites and other Network and Technology Providers. In one embodiment of the invention, every Content Publisher can define his own “Distribution Basis” when registering content. In another embodiment of the invention, the “Distribution Basis” is partly or completely predetermined by the operator of the Clearing House Site (102). In another embodiment of the invention, all or some of the values of the “Distribution Basis” can be set by the Content Buyer. In another embodiment of the invention, the kind of reward can be selected by the Content Buyer from a list of options.

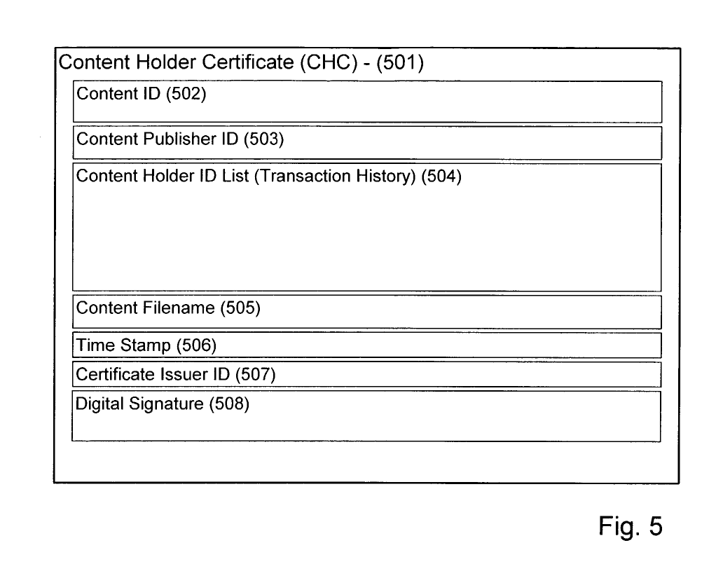

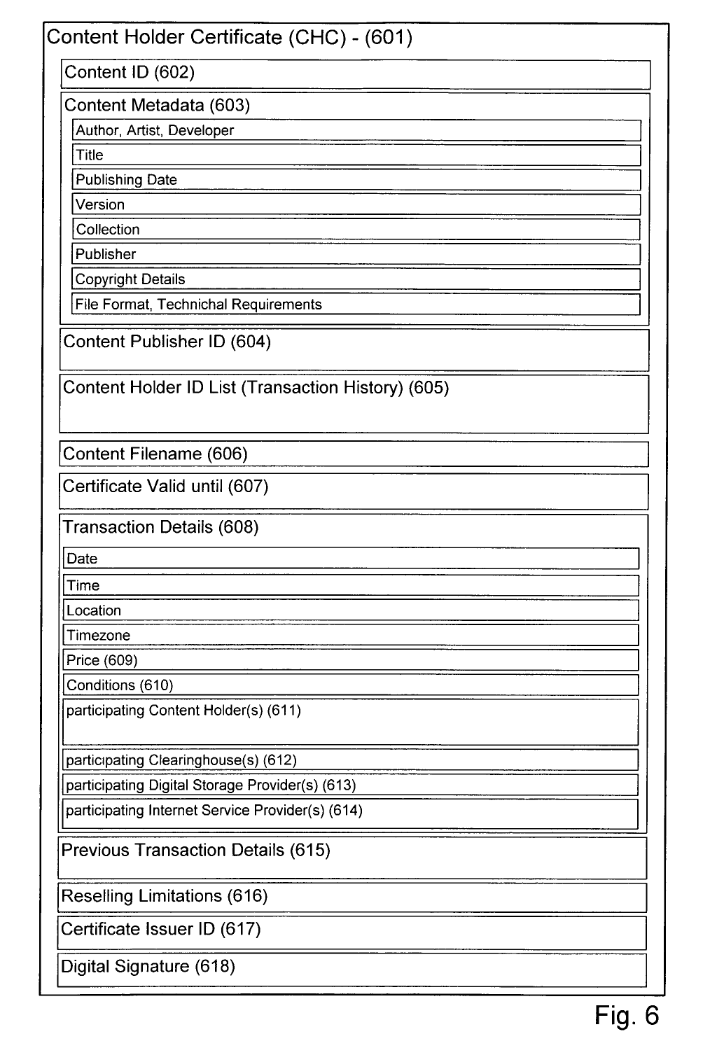

The Meta-Data, the “Pricing, Terms and Conditions” Information, the “Distribution Basis” Information and the Checksum are now transmitted (202) to the Clearinghouse using the Content Transaction Application (107) and the Content Transaction Manager (112), which stores the data and uses it in order to generate a “Content Holder Certificate” (“CHC”) using the “Certificate Processing Application” (114). The “Content Holder Certificate”, which is illustrated in FIG. 5 (basic version) and in FIG. 6 (advanced version), proves its holder (identified by it's Content-Holders User-ID (504)) to be a legal owner and/or reseller of a specified content (identified by a Content-ID (502) issued by the Clearing House Site (102)) and stores additional data such as the filename of the content (503) and the transaction history (504).

In one embodiment of the invention, the Content-ID (502) and the Content-Holders User-ID (504) are processed into a single ID, the “Unique-Content-ID”, using a one way encryption algorithm. A one way encryption algorithm delivers a result that can not be reversed to find the original data, so in this application no one can extract the original IDs from the “Unique-Content-ID”. This Unique-Content-ID can be used to identify and request a desired content while it hides and protects the Content Holders User-ID.

This invention enables users of the system to resell content they have legally obtained through the system to one or more other users of the system. To encourage users to resell contents, they may participate in the profits and in future profits generated by the system, e.g. by paying them a commission or by offering them a premium or a credit note for future content purchases. Therefore, in a preferred embodiment of the invention, each sale and resale of a specific content file is stored by the system. In a preferred embodiment, the “Transaction History” part (504, 605) of the Content Holder Certificate contains the ID of the current Holder of the respective Content as well as all of the previous Content-Holders User-ID's. In another embodiment of the invention the number of previous Content Holders User-ID's is limited.

In a preferred embodiment of the invention, the Content Holder Certificate is signed digitally and is partly or entirely encrypted by the Clearing House Application (111) using the Public Key Infrastructure (113) in order to prevent manipulation or display of private data. In another embodiment, illustrated in FIG. 6, the Content Holder Certificate (601) also holds additional information such as Publishing Date, Version, Technical Requirements, File Format, Transaction Details and Reselling Limitations.

The Clearing House Site (102) now sends (203) the Content Holder Certificate to the Content Publishing Device (101) and, in a preferred embodiment, stores Pricing, Meta-Data and Checksum information for further reference in its database or in a separate Database Site accessible by the Clearing House Site (102).

In another embodiment of the invention, the information of the Content Holder Certificate is not stored and transmitted separately, but is inserted into the content. In one embodiment of the invention, this is done by inserting the information into the “header” of the digital content file. The header section of a digital content file precedes or follows the main content and contains information about the file or the content. In another embodiment of the invention, this is done using Watermarking technology or Steganography (data hiding) technology. Steganography is Greek for “covered writing” and usually means “hiding information in other information”. Using Steganography technology, a text-file can be hidden, for example in an image-file. The image-file can be transferred without anybody suspecting it to carry other information than visible in the image. The image itself is not recognizably altered. Watermarking technology does not only hide information (such as copyright information) in contents such as images or music, but is also supposed to be resistant against attacks and manipulations. More information on Watermarking and Steganography can be found at bttp://www.watermarkingworld.org/faq.html.

In another embodiment of the invention, the information of the Content Holder Certificate is not stored and transmitted separately, but is stored in a central database at the Clearing House Site (102) or in a separate Database Site accessible by the Clearing House Site (102).

Content Sale

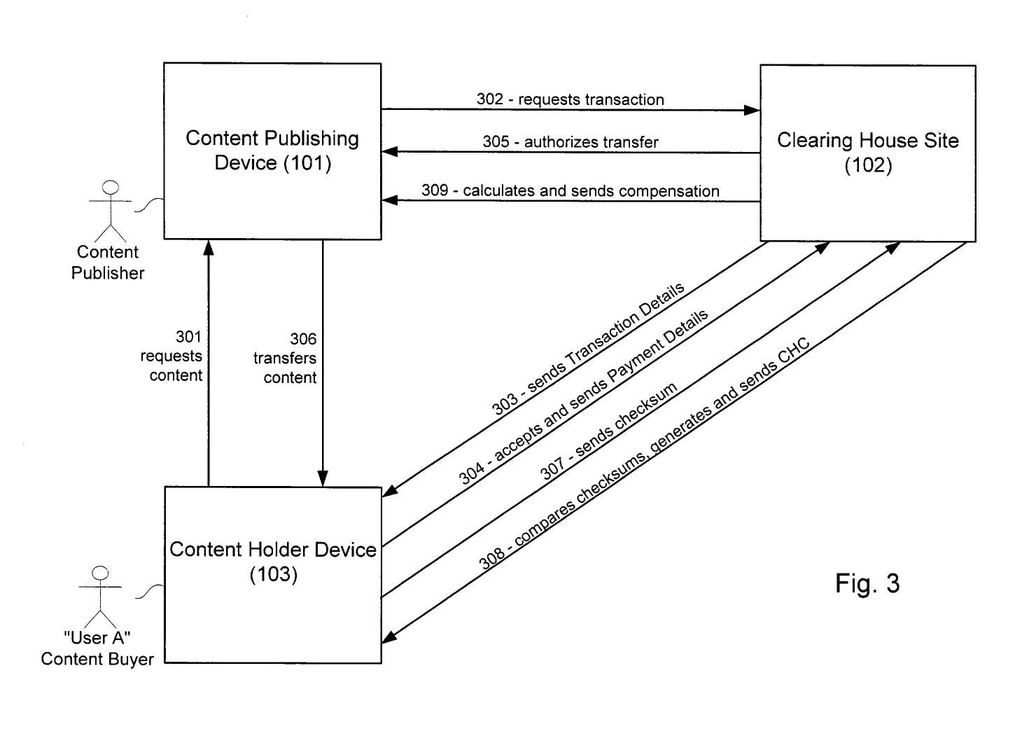

FIG. 3 illustrates the Content Selling Process according to one embodiment of the present invention. The Content Publisher offers content for sale. Users of the System are not limited in selecting the method of presenting or advertising the offered Content. For example, the Content can be presented on a Web-Page, in an E-Mail-Message, in an online discussion forum, on an FTP-Server or via a P2P-Software-Program. What is important is that the offer contains data identifying the content and the offeror, such as the Content-ID, the User-ID or the unique Content-ID mentioned above. The prospective buyer (“User A”) can then use this data to request the Content (301) from the Sellers Content Publishing Device (101) by using the Content Trading Tool (117) of his Content Holder Device (103). The Content Transaction Application (119) establishes contact with the Content Publishing Device (101) of the Content Publisher, identifies with the prospective buyer's User ID and requests the desired content.

The Content Transaction Application (107) of the Content Publishing Device (101) now requests a transaction (302) from the Clearing House Site (102) by sending the Content Holder Certificate and the User ID of the prospective buyer “User A” to the Clearing House Site (102). The Clearing House Application (111) of the Clearing House Site (102) now sends Transaction Details (303) such as the price, terms and conditions to the Content Holder Device (103). “User A” now has to accept the Transaction Details such as the price, terms and conditions, and send the Payment Details (e.g. Credit Card Information) (304) to the Clearing House Site (102). The Clearing House Site (102) uses the Payment Processing Application (115) in order to validate the Payment Details. If the validation returns a positive result, the Clearing House Site (102) authorizes the transfer (305) of content from the “Content Publishers” Content Publishing Device (101) to “User A's” Content Holder Device (103). The File Transfer Application (109) of the Content Publishing Device (101) now enables the File Transfer Application (121) of “User A's” Content Holder Device (103) to transfer the content. This can be done by a variety of technical approaches, examples are: using a specially generated Hyperlink, that is only known to the Content Buyer, granting “User A” a time-limited access authorization to the Content Publishing Device (101), or by actively sending the file from the Content Publishing Device (101) to a specified, publicly accessible folder on “User A's” Content Holder Device (103). In another embodiment of the innovation, the content can even be transferred “offline” via data media such as floppy disks, CD-ROMs, DVDs, etc.

The Content Holder Device (103) now uses the Error Detection Algorithm (120) in order to generate a checksum. This checksum is sent (307) to the Clearing House Site (102), where the Clearing House Application (111) compares it with the original checksum generated by the Content Publishing Device (101) in order to prevent transmission errors or fraudulent manipulation of the content. If the comparison returns a positive result (meaning the transferred file is equal to the original file), the Certificate Processing Application (114) of the Clearing House Site (102) generates a new Content Holder Certificate and sends (308) it to the Content Holder Device (103). “User A” is now a legal “Content Holder” and can use and—if allowed in the terms and conditions of the transaction—legally resell the content. If the comparison of the checksums returns a negative result (meaning the transferred file is not equal to the original file), an error message is issued allowing the participating parties to take appropriate steps such as retransmitting the data.

According to the information from the Content Holder Certificate and the Distribution Basis, the Billing Application (116) of the Clearing House Site (102) now processes the payment and calculates commissions, premiums, credit notes or other rewards and sends it (309) to the Content Publishing Device (101).

Content Resale

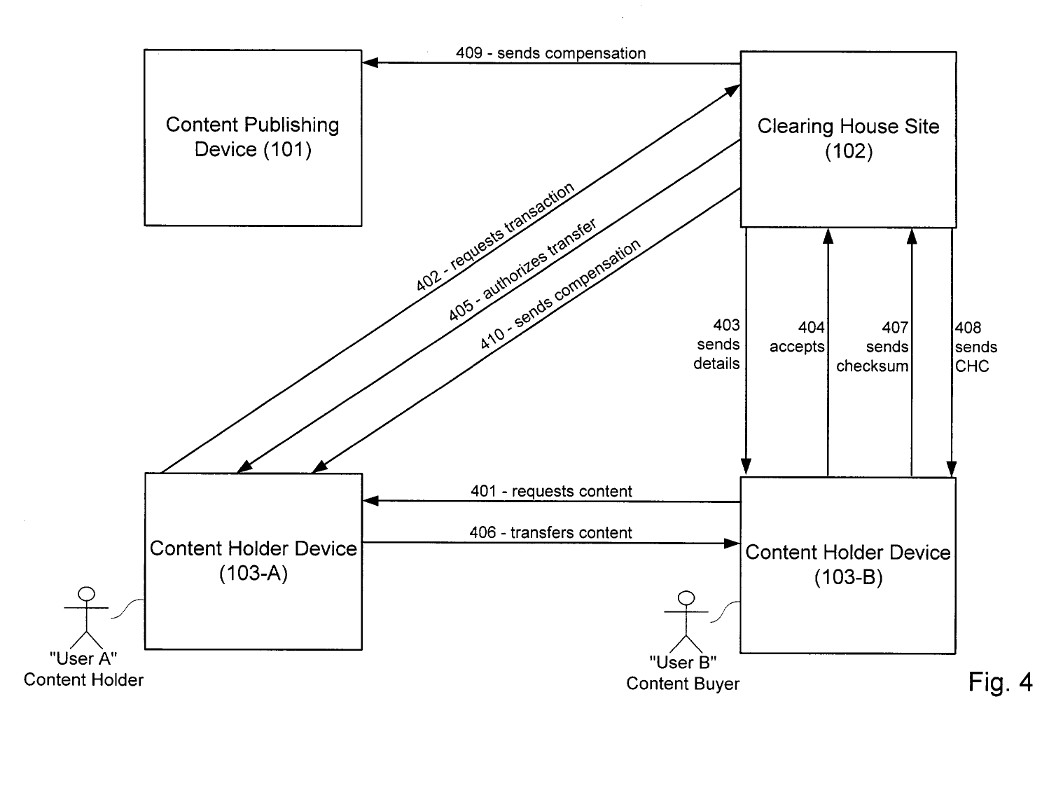

FIG. 4 illustrates the Content Reselling Process according to one embodiment of the present invention. Now, the Content Holder “User A” offers the content that he acquired in FIG. 3 for sale. As described above, the prospective buyer (now “User B”) uses the Content-ID (or the Unique-Content-ID) to request the Content (401) from the Content Holder Device (103-A) by using the Content Transaction Application (119) of his Content Holder Device (103-B). The Content Transaction Application (119) of the Content Holder Device (103-B) of Content Buyer “User B” establishes contact with the Content Holder Device (103-A) of the Content Holder “User A”, identifies with “User B's” User ID and requests the content.

The Content Transaction Application (119) of “User A's” Content Holder Device (103-A) now requests a transaction (402) from the Clearing House Site (102) by sending the Content Holder Certificate and the User ID of the prospective buyer “User B” to the Clearing House Site (102). The Clearing House Site (102) now sends Transaction Details (403) such as the price, tenns and conditions to the Content Holder Device (103-B) of “User B”. The “User B” now has to accept the Transaction Details such as the price, terms and conditions, and sends (404) the Payment Details (e.g. Credit Card Information) to the Clearing House Site (102). The Clearing House Site (102) uses the Payment Processing Application (115) in order to validate the Payment Details. If the validation returns a positive result, the Clearing House Site (102) authorizes the transfer (405) of content from “User A's” Content Holder Device (103-A) to “User B's” Content Holder Device (103-B). The File Transfer Application (109) of the Content Holder Device (103-A) now enables the File Transfer Application (121) of “User B's” Content Holder Device (103-B) to transfer the content. This can be done using variety of technical methods, examples are: granting the Content Holder Device (103-B) of “User B” a time-limited access authorization to the Content Holder Device (103-A) of “User A”, or by making the respective content-file exclusively accessible to the Buyer applying the user/rights-management-functions of the used operating system, by applying authorization methods of the used web-server-software, or by actively sending the file from the Content Holder Device (103-A) to a specified, accessible folder on “User B's” Content Holder Device (103-B). In another embodiment of the innovation, the content can even be transferred “offline” via data media such as floppy disks, CD-ROMs, DVDs, etc.

The Content Holder Device (103-B) now uses the Error Detection Algorithm (120) in order to generate a checksum. This checksum is sent (407) to the Clearing House Site (102), where it is compared with the original checksum generated by the Content Publishing Device (101) in order to prevent transmission errors or fraudulent manipulation of the content. If the comparison returns a positive result (meaning the transferred file is equal to the original file), the Clearing House Site (102) generates a new Content Holder Certificate and sends (408) it to the Content Holder Device (103-B) of “User B”, which can now prove to be a legal holder and/or reseller of a specified content and—if allowed in the terms and conditions of the transaction—legally resell the content. In a preferred embodiment, the new Content Holder Certificate contains the information, that “User B” acquired the Content from “User A” (“Transaction History”, 504, 605).

According to the information stored in the Content Holder Certificate, the Billing Application (116) of the Clearing House Site (102) now processes the payment and calculates commissions, premiums, credit notes or other compensation and sends it (409) to the Content Publishing Device (101) of the original Content Publisher and to the Content Holder Device (103-A) of the participating Reseller “User A” (410).

Content Holder Certificate (CHC)

FIG. 5 illustrates a simple Content Holder Certificate according to one embodiment of the present invention. The Content Holder Certificate (501) includes a series of components: The Content-ID (502) is a number or a string uniquely identifying the respective content. In a preferred embodiment, the Content Holder Certificate (501) also includes a Content Filename (505), that describes the name of the digital file containing the respective content. In addition, the Content Holder Certificate (501) includes the Content Holder ID List (504), that contains the ID of the Holder of the respective content and (where applicable) the previous Content Holders IDs. In addition, the Content Holder Certificate (501) includes a Time Stamp (506), identifying the date and time the certificate was issued. In addition, the Content Holder Certificate (501) includes a Certificate issuer ID (507) that identifies the issuer (the Clearing House Site) of the Certificate. In addition, the Content Holder Certificate (501) includes a Digital Signature (508) that proves the origin and the originality of the Certificate.

In one embodiment, the Content Holder Certificate contains human-readable text in the ASCII-Format. In another embodiment, a markup-language such as XML is employed for creating the certificate. In another embodiment, the certificate complies with a Standard such as the X.509 Standard.

The Content Holder Certificate (CHC) is issued by the Clearing House Site. As described above, a Content Publisher requests a new Content Holder Certificate by sending data such as the Filename and the Checksum to the Clearing House Site (102) using the Content Publishing Tool (105) of his Content Publishing Device (101). The Clearing House Application of the Clearing House Site (102) assigns a Content ID (502) to the Content, and stores the ID of the legal holder of the Content—in this case the Content Publisher—and the checksum in the Certificate. The certificate is then signed and sent to the Content Publisher (FIG. 2, 203).

Each time “Content” is sold or resold, a new Content Holder Certificate is created and issued to the Buyer. The new Content Holder Certificate is based on the Information of the Sellers Content Holder Certificate. Therefore the Clearing House reads the Content Holder ID (504) of the Seller from the respective Content Holder Certificate (501) and adds the Buyer to the Content Holder ID List (504) of the newly issued Content Holder Certificate (501) for the Buyer. In this way, the previous Holders of the respective content are stored and can be identified and rewarded for future transactions.

FIG. 6 illustrates an advanced Content Holder Certificate according to one embodiment of the present invention. The Content Holder Certificate (601) includes a series of components: The Content ID (602) is a number or a string uniquely identifying the respective content. The Content metadata (603) contains additional information about the content such as the Author, Artist or Developers Name, the Title, the Publishing Date, the Version, the Collection the content belongs to (e.g. an album), the Publisher, Copyright Details and the File Format as well as technical requirements for using the content. In addition, the Content Holder Certificate (601) includes the Content Publisher ID (604), that identifies the Publisher of the respective content. In addition, the Content Holder Certificate (601) includes the Content Holder ID List (605) that that contains the ID of the Holder of the respective content and (where applicable) the previous Content Holders IDs. In a preferred embodiment, the Content Holder Certificate (601) also includes a Content Filename (606), that describes the name of the digital file containing the respective content. In a preferred embodiment, the Content Holder Certificate (601) also includes Validity Information (607), that describes the duration of validity of the Content Holder Certificate. In addition, the Content Holder Certificate (601) includes Transaction Details (608) such as the date and time of the respective transaction, the location and timezone of the content seller, the price (609), terms and conditions (610) of the transaction, the participating Content Holder(s) (611), the participating Clearing House(s) (612), the participating Digital Storage Provider(s) (613) and the participating Internet Service Provider(s) (614). In one embodiment, the Content Holder Certificate (601) includes in addition the Previous Transaction Details (615) that contain all Transaction Details of previous transactions. In addition, the Content Holder Certificate (601) includes Reselling Limitations (615) that contain information on if and on what terms the content may be resold. In addition, the Content Holder Certificate (601) includes a Certificate issuer ID (617) that identifies the issuer (the Clearing House Site) of the Certificate. In addition, the Content Holder Certificate (601) includes a Digital Signature (618) that proves the origin and the originality of the Certificate.

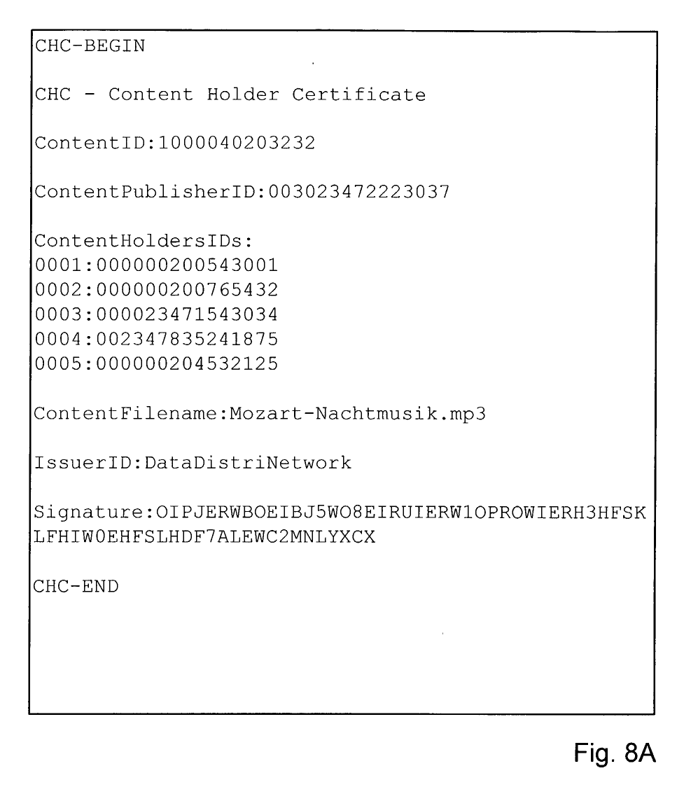

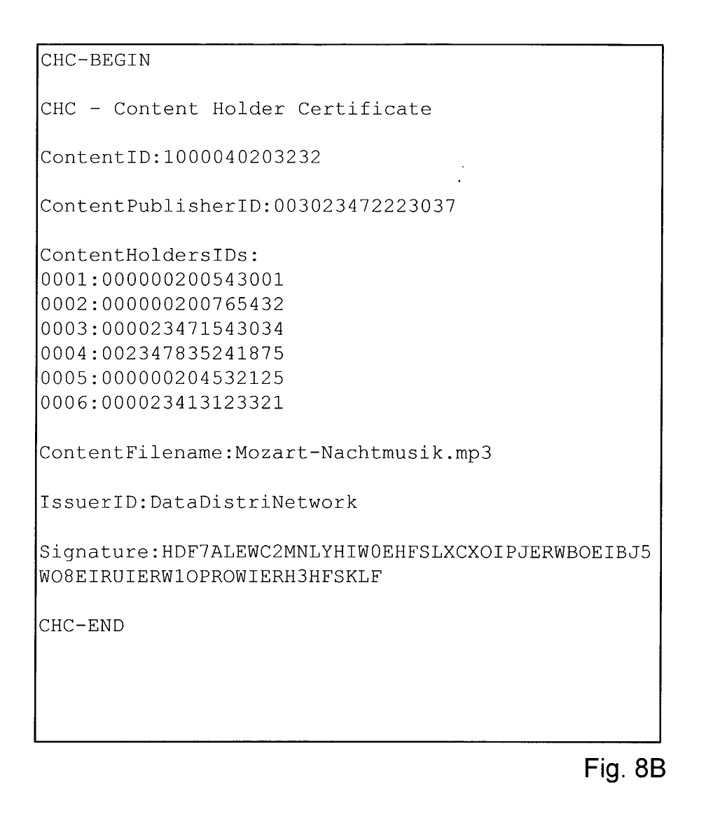

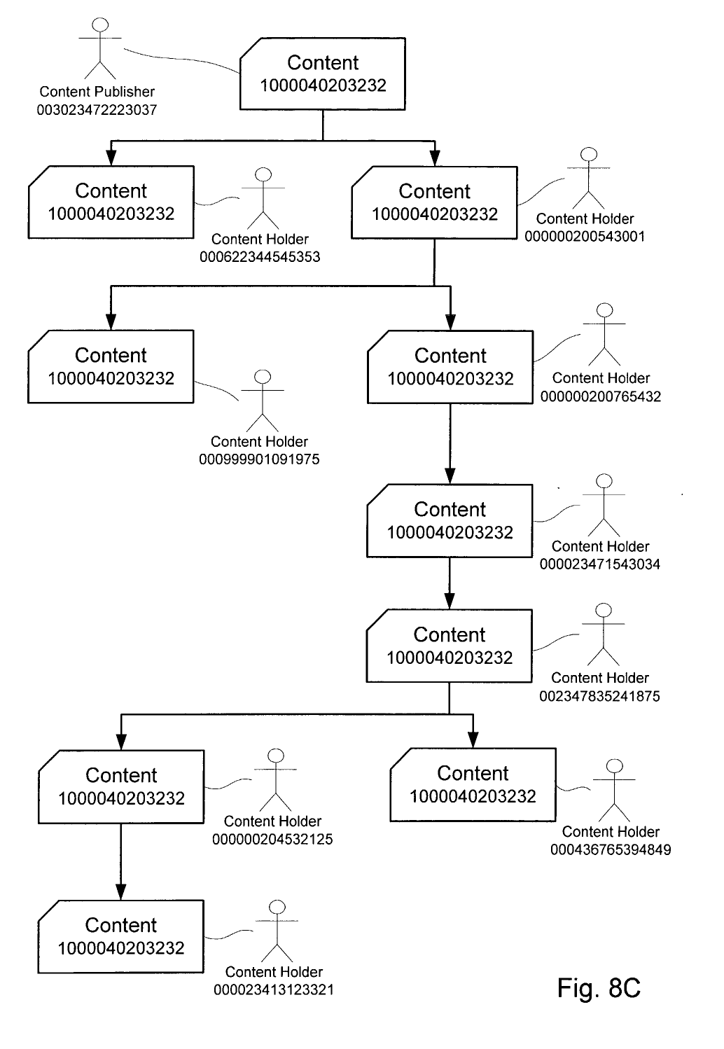

FIG. 8A illustrates an example for a basic Content Holder Certificate according to one embodiment of the present invention. The Certificate contains the ContentID of the respective content, the Content Filename of the respective content, the Content Publisher ID of the Publisher of the respective Content and the List of Content Holder IDs, which contains the Content Holder ID of the current Holder of the respective Content, and (where applicable) the previous Content Holders IDs. The first User on this list (0001:000000200543001) is the first holder of the Content, in many cases the Content Publisher. He sold the content to the next User on the list (0002:000000200765432), who resold the content to the next User on the list (0003:000023471543034) and so on. The last user on the list is the current Content Holder (0005:000000204532125) of the respective Content, he purchased the Content from User 0004:002347835241875.

If the current Content Holder resells the content to another User, this invention facilitates, that all or some of the previous Content Holders as well as the Content Publisher can be rewarded. The kind and amount of reward given depends on the respective implementation of the invention and the Terms and Conditions specified by the Content Publisher and the operators of the Clearing House Site(s).

In the new Content Holder Certificate (illustrated in FIG. 8B) that is generated by the Clearing House Site (102) and sent to the Buyer, the new Content Holder (in this example ID 000023413123321) was added to the List of “Content Holder IDs” as “0006:000023413123321”. In addition, the new Content Holder Certificate contains an issuer ID identifying the issuer of the certificate (the Clearing House Site (102)), the Content Publisher ID and a digital signature that proves the origin and the originality of the Certificate.

FIG. 8C illustrates, according to one embodiment of this invention, how the transaction history stored in the List of Content Holder IDs is created, using the example data from FIG. 8B. The Content Publisher with the User-ID 003023472223037 sells Content (for example a Digital Music File) with the Content ID 1000040203232 to Content Holder 000000200543001. Content Holder 000000200543001 resells the Content to two users: Content Holder 000999901091975 and Content Holder 000000200765432. The three of them are now in a position to use and to resell the Content. Content Holder 000000200765432 resells the content to Content Holder 000023471543034, who resells the Content to Content Holder 002347835241875. Content Holder 002347835241875 resells the Content to Content Holder 000436765394849 and to Content Holder 000000204532125, who resells the Content to Content Holder 000023413123321. According to one embodiment of this invention, the Content Holder Certificate issued to Content Holder 000023413123321 now complies with that illustrated in FIG. 8B, while the Content Holder Certificate issued to Content Holder 000000204532125 complies with that illustrated in FIG. 8A. In this embodiment of the invention, the data stored in the section “ContentHolderIDs” is the “Transaction History” of said Content.

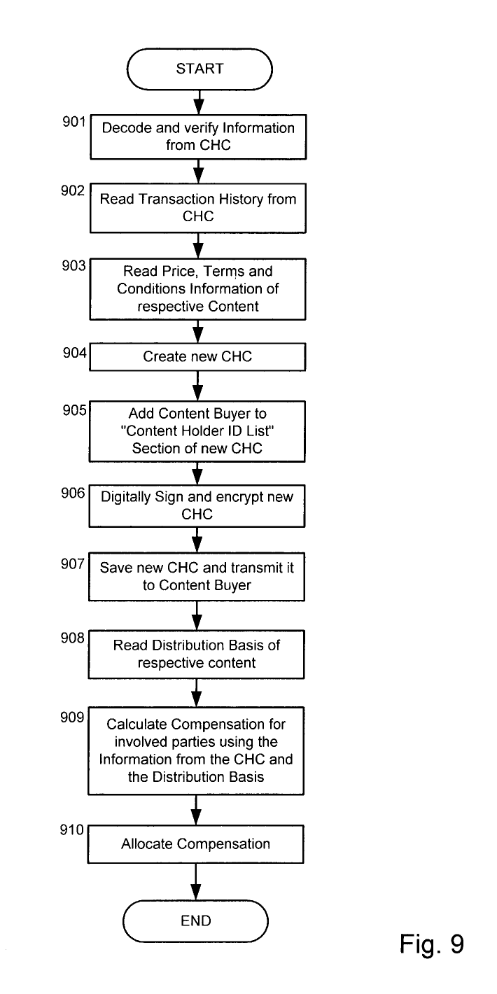

FIG. 9 is a flow diagram illustrating a process in which the Clearing House Application (111) of the Clearing House Site (102) generates a new Content Holder Certificate (CHC) and calculates commissions for the parties that participated in a content transaction according to one embodiment of the present invention. As illustrated in FIG. 3 and FIG. 4, the Clearing House Site (102) is, amongst other things, responsible for the creation of Content Holder Certificates and for the calculation of rewards for the parties involved in a content transaction. The process illustrated in FIG. 9 starts, when the Clearing House Site (102) receives the matching checksum from the “Content Buyers” Content Holder Device (103) as shown in FIG. 3 (307) and FIG. 4 (407). The Clearing House Application (111) running on the Clearing House Site (102) decodes and verifies (901) the Information from the Content Holder Certificate received (302, 402). Next, the Clearing House Application (111) reads the Transaction History from the Content Holder Certificate (902). Next, the Clearing House Application (111) reads (903) the Price, Terms and Conditions Information from it's database, or, where applicable, from the Content Holder Certificate and checks it for validity. In another embodiment of the invention, the Clearing House Site (102) can also access the Database(s) of other Clearing House Site(s) or other Publishing Devices over the Communications Network (104) in case it does not have the required information present in it's own database. Next, the Clearing House Application (111) opens a new Content Holder Certificate (904) and stores the information from the Sellers Content Holder Certificate in said new Certificate. Next, the Clearing House Application (111) adds (905) the Content Buyers User-ID to the Content Holder ID List Section of the New Content Holder Certificate. Next, the Public Key Infrastructure (113) of the Clearing House Application (111) is used to digitally sign (906) the new Content Holder Certificate. In one embodiment, the Content Holder Certificate is in addition entirely encrypted by the Clearing House Application (111) in order to prevent manipulation or display of private data. In another embodiment, only the Content Holder ID List, and—where applicable—the Transaction Details (608) and the Previous Transaction Details (615) of the Content Holder Certificate are encrypted by the Clearing House Site (102). Now the new Content Holder Certificate is saved and transmitted (907) to the Content Buyer. Next, the Billing Application (116) reads the Distribution Basis of the respective Content from it's Database (908). Next, the Billing Application (116) uses the information from the Content Holder Certificate, the Price, Terms and Conditions Information and the information from the Content Holder Certificate to calculate the rewards for the parties involved in the transaction (909). Then the Billing Application (116) allocates the rewards to the involved parties (910).

In other embodiments of the Invention, this is done by using bank transfer, electronic cash, a digital credit note or other forms of electronic payment, or by offering the involved parties a premium or a credit note for future content purchases. In one embodiment of the invention, the Clearing House Site (102) keeps accounts for the participants in the system and books the rewards to the particular accounts, from where they can be drawn on demand, on a regular basis or when certain limits are met.

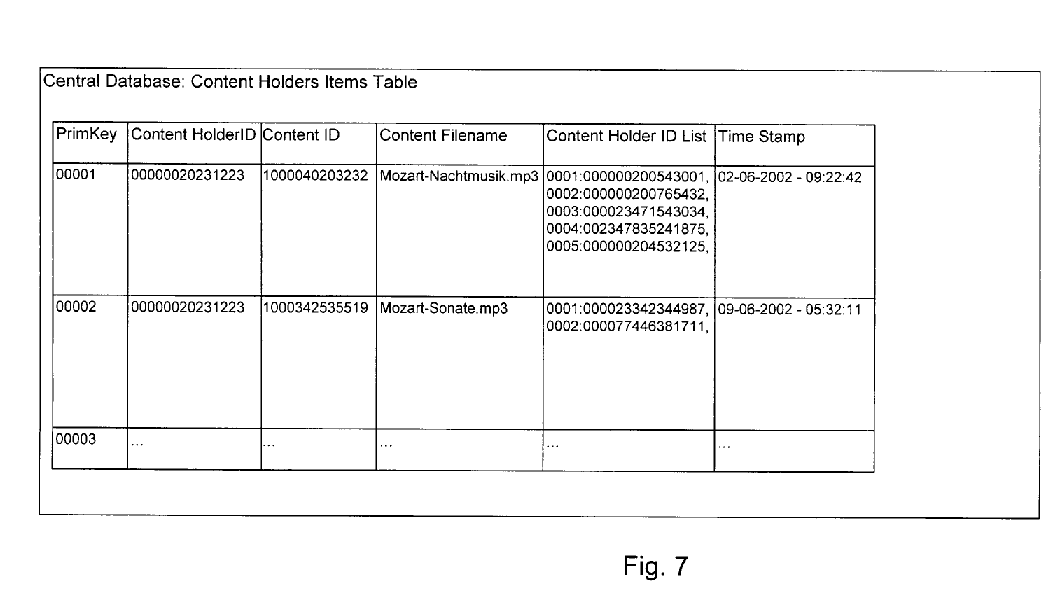

As mentioned above, another embodiment of the invention uses a Central Database at the Clearing House Site (102) or a separate Database Site accessible by the Clearing House Site (102) instead of a Content Holder Certificate (CHC) in order to store data such as Data identifying Contents, Meta-Data about the Contents, Data identifying Content Holders and Data identifying Content Publishers. In a preferred embodiment, said Database contains data identifying at least one “Content Holder”, data identifying the Contents acquired by said Content Holder(s) and data identifying previous Holders of said acquired Contents. In one embodiment, the Database further contains information such as: Meta-Information about the contents such as the Author, the Title, the Filename, the File-Format; the Price for acquiring contents, the “Terms and Conditions” for selling the contents, the “Distribution Basis” of the contents and the checksums of the content-files. FIG. 7 illustrates an example for data maintained in a “Content Holders Items Table” stored at the Clearing House Site or a Database Site accessible by the Clearing House Site according to another embodiment of the present invention. In the Table illustrated in FIG. 7, all the Contents (“Items”) obtained by the Content Holders are listed. In this embodiment, the Contents are identified by Content IDs. Further information stored in the “Content Holders Items Table” in this embodiment is: a primary key, the Content Filename, the Content Holder ID List and a Time Stamp. In this embodiment, said Content Holder ID List contains data identifying all previous Holders of the particular content. In another embodiment of the invention, lists such as the Content Holder ID List are stored in a separate table.

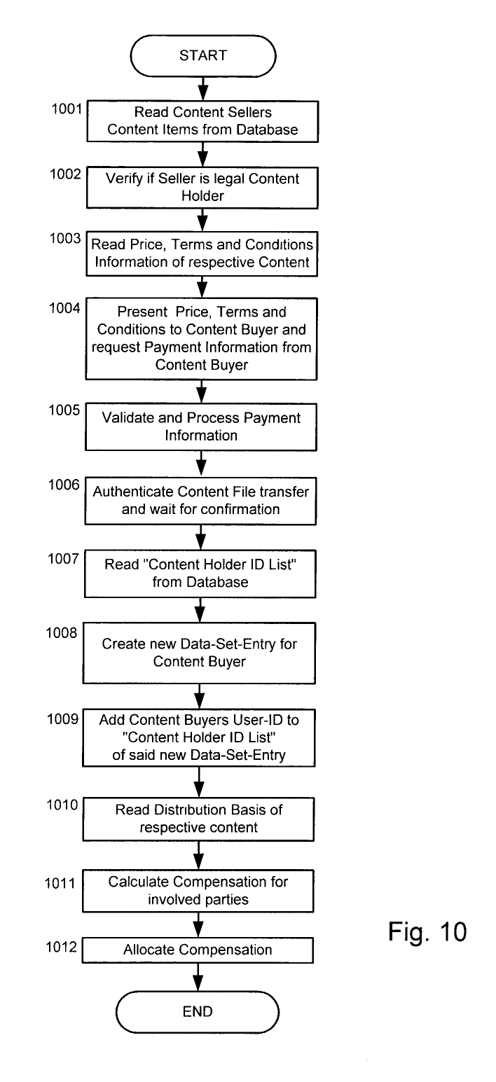

FIG. 10 is a flow diagram illustrating a process in which the Clearing House Site (102) uses a Database instead of a Content Holder Certificate in order to process Content Transactions and to calculate commissions for the parties that participated in a content transaction according to one embodiment of the present invention. The process starts when a Content Holder (in the following referred to as the “Content Seller”) uses his Content Holder Device (103) in order to request a transaction, because another user (in the following referred to as the “Content Buyer”) wants to acquire content from him. The Clearing House Application (111) accesses the Central Database or the Database Site, reads the List of Content Items acquired by the Content Seller (1001) and checks, if the Content Seller is a legal holder of the respective Content (1002) and is therefore entitled to resell it. If so, the Clearing House Application (111) reads Price, Terms and Conditions Information (1003) of the respective Content and presents this information (1004) to the prospective Content Buyer and requests Payment Information. Examples for Payment Information are: the desired way of payment, payment details as credit card number and expiry date, banking account number, account number of an online payment service provider, a PIN-Code, a TAN-Code or the code of a voucher or a gift coupon. In one embodiment of the invention, the Clearing House Site (102) keeps accounts for Publishers and Content Holders and stores proceeds and expenses for purchases and sales of contents in order to clear them later, in this embodiment, the user can select the option “charge my user account” as Payment Information. The prospective Content Buyer now has to accept the Price, Terms and Conditions and to send the required Payment Information. The Payment Processing Application (115) running on the Clearing House Site (102) now validates the received Payment Information (1005) and if the validation returns a positive result, the Clearing House Application (111) processes the payment using the Payment Processing Application (115) and authorizes the transfer (1006) of the content from the Content Sellers device to the Content Buyers device.

In a preferred embodiment of the invention, the Clearing House Application (111) now waits for confirmation of successful transfer of the content. In a preferred embodiment of the invention, an Error Detection Algorithm (120) is used in order to confirm the successful transfer of the content: When the Content Buyers device received the Content File, it uses the Error Detection Algorithm (108) for generating a checksum. This checksum is compared with the “original checksum” generated by the Content Publisher when registering the particular content with the Clearing House Site (102) in order to prevent transmission errors or fraudulent manipulation of the content. If the comparison returns a positive result, the successful transfer is confirmed, otherwise an error message is issued allowing the participating parties to take appropriate steps such as retransmitting the data.

Now the Clearing House Application (111) reads the “Content Holder ID List” of the particular Content-Item (the List of previous Holders of said Content-File) from the Database (1007) and creates (1008) a new Data-Set-Entry for the Content Buyer and adds (1009) the Content Sellers User-ID to the “Content Holder ID List” of said new Data-Set-Entry. Now the Clearing House Application (111) reads the Distribution Basis Information of the particular Content from the Database and uses said Distribution Basis Information, said “Content Holder ID List” and the Price Information of said Content to calculate (1011) Compensation for the parties involved in the transaction. Now the Clearing House Application (111) uses the Billing Application (116) in order to allocate (1012) the Compensation to said involved parties.

In one embodiment of the invention, after every transaction a confirmation message is sent to the involved parties. In another embodiment of the invention, text-files are used instead of a database in order to store Content Holder ID Lists and other Data.

I claim:

1. A computer-implemented system for content distribution and reselling over a communications network, the system comprising:
at least one Content Publishing Device transmitting Content Meta Information, Price and Distribution Basis Information to a Clearing House Site; and
at least one Clearing House Site storing Content Meta Information, Price and Distribution Basis Information and Transaction History Data, processing Content Transactions and calculating rewards for the parties involved in a content transaction based on Transaction History Data and a Distribution Basis; and
at least one Content Holder Device processing Content Transactions with Clearing House Sites, Content Publisher Devices and other Content Holder Devices.

2. A method for generating a reward for at least one Seller of Digital Content, said method comprising the steps of
accessing transaction history data associated with said Digital Content;
determining the Seller and at least one previous Holder of said Digital Content;

3. The method of claim 2, the method further comprising the step of
storing transaction history data of each Copy sold of said Digital Content.

4. The method of claim 2, the method further comprising the step of
determining a reward based on said Information about previous Holders of said Digital Content.

5. The method of claim 2, the method further comprising the step of
accessing Distribution Basis data associated with said Digital Content;
determining reward rates based on said Distribution Basis;

6. The method of claim 2, the method further comprising the step of
determining rewards for the Publisher of said Digital Content based on Distribution Basis Data.

7. The method of claim 2, the method further comprising the step of
determining rewards for the Clearing House Site involved in the transaction based on Distribution Basis Data.

8. A method for generating a reward for at least one Seller of Content, said method comprising the steps of
accessing transaction history data of said Content;
accessing Distribution Basis data of said Content;
accessing Pricing data of said Content;
determining previous Holders of said Content;
determining rewards for said Seller, said Publisher and said previous Holders of said Content based on said Distribution Basis and said Pricing data.

9. The method of claim 8, the method further comprising the steps of
determining the Publisher of said Content;
determining rewards for said Publisher of said Content based on said Distribution Basis and said pricing data.

10. The method of claim 8, the method further comprising the step of
determining at least one Network Service Provider involved in the transaction;
determining rewards for said Network Service Provider based on said Distribution Basis Data.

11. The method of claim 8, the method further comprising the step of
determining the Clearing House Site involved in the transaction;
determining rewards for said Clearing House based on said Distribution Basis Data.

12. A method for creating a digitally stored Digital Certificate of Content Ownership for a Buyer of Content, the method comprising the steps of
storing data identifying the Content in said Certificate;
storing data identifying the Content Buyer in said Certificate;
storing data identifying the Content Seller in said Certificate;
storing data identifying at least one previous Content Holder of said Content in said Certificate.

13. The method of claim 12, the method further comprising the steps of
reading and verifying Information from an existing Digital Certificate of Content Ownership;
reading data identifying at least one previous Content Holder from said existing Digital Certificate of Content Ownership;
adding data identifying the Content Seller to said data identifying at least one previous Content Holder;
adding said new data identifying the previous Content Holders to the newly created Digital Certificate;

14. A method for selling Digital Content, said method comprising the steps of
verifying if Seller is legal holder of said Content;
accessing Pricing Information;
requesting Payment Information from said prospective Buyer;
processing said Payment Information;
enabling the transfer of said Content;
accessing Distribution Basis data of said Content;
determining at least one previous Holder of said Content;
determining rewards for said previous Holders of said Content based on said Distribution Basis and said pricing data.

15. The method of claim 14 in which prior to the step of accessing Distribution Basis data of said content, the method further comprises the step of:
verifying the correct transfer of said Content.

16. The method of claim 14 in which prior to the step of processing said Payment Information, the method further comprises the step of:
presenting Price, Terms and Conditions Information to the prospective Buyer of said Content.

17. The method of claim 14 in which prior to the step of requesting Payment Information, the method further comprises the step of:
accessing Terms and Conditions Information of said Content;

18. The method of claim 14 in which prior to the step of determining rewards for said previous Holders of said Content, the method further comprises the steps of:
determining the Publisher of said Content;
determining rewards for said Publisher of said Content based on said Distribution Basis and said pricing data.

19. A digitally stored Digital Certificate of Content Ownership comprising a list of previous Content Holders.

20. A device for generating a reward for at least one Seller of Content, said device comprising of:
a memory configured to store:
price data associated with content-items;
distribution basis data associated with content-items;
transaction history data associated with content-items and content-holders;
reward data associated with content holders;
and a processor operatively connected to said memory, configured to:
access said transaction history data;
determine said reward data based on said distribution basis data, said transaction history data and said price data.
